(19) United States
(12) Patent Application Publication
(10) Pub. No.: US 2006/0048823 A1
(43) Pub. Date: Mar. 9, 2006

(54) Shut-off device and fueling apparatus for fuel tank

(76) Inventor: Hiroyuki Hagano, Aichi-ken (JP)

Correspondence Address: POSZ LAW GROUP, PLC, 12040 SOUTH LAKES DRIVE, SUITE 101, RESTON, VA, 20191, US

(21) Appl. No.: 11/218,724

(22) Filed: Sep. 6, 2005

(30) Foreign Application Priority Data
Sep. 8, 2004 (JP) 2004-260545
Jul. 28, 2005 (JP) 2005-218773

(51) Int. Cl. F16K 37/00

(52) U.S. Cl. 137/557

(57) ABSTRACT

A fuel cap easily realizes a function to warn the user that the pressure regulating valve is activated as backup means for the fuel tank pressure adjustment mechanism. The fuel cap includes a negative pressure valve that regulates the fuel tank pressure. An alarm mechanism is disposed upstream from the negative pressure valve. The alarm mechanism issues a warning that the negative pressure valve of the pressure regulating valve is activated as a backup for the fuel tank pressure adjustment mechanism by emitting sound via a whistle mechanism when air flow takes place due to the opening of the negative pressure valve.

This application claims the benefit of and priority from Japanese Application No. 2004-260545 filed Sep. 8, 2004 and No. 2005-218773 filed Jul. 28, 2005, the contents of which are incorporated herein by reference.

### BACKGROUND OF THE INVENTION

1. Field of the Invention

The present invention relates to a shut-off device that includes a pressure regulating valve that serves as a backup to prevent damage to a fuel tank, as well as to a fueling apparatus for a fuel tank.

2. Description of the Related Art

The fuel tank of an automobile conventionally includes a pressure adjustment mechanism that prevents deformation of or leakage from the fuel tank by adjusting its internal pressure. At the same time, a technology in which a positive/negative pressure valve (pressure regulating valve) is incorporated in a fuel cap that opens and closes the tank opening of a fuel tank is also known (see JP-A-P10-278958). The positive/negative pressure valve of the fuel cap opens when the pressure adjustment mechanism does not work properly, and operates as backup means to prevent damage to the fuel tank by preventing a drop in fuel tank pressure.

However, the operation of the positive and the negative pressure valve of the fuel cap for backup means cannot be checked from the outside.

### SUMMARY OF THE INVENTION

An advantage of some aspects of the invention it to provide a shut-off device having a function to notify the user that a pressure regulating valve operating for backup means for the pressure adjustment mechanism of a fuel tank is activated, as well as a fueling apparatus for a fuel tank.

In accordance with an embodiment of the invention is to provide the shut-off device that includes a pressure regulating valve that regulates an inner pressure of a fuel tank, and an alarm mechanism that indicates that the pressure regulating valve is activated due to an air flow resulting from an opening action of the pressure regulating valve.

With the shut-off device of the present invention, the occurrence of damage to the fuel tank due to an increase in the difference between the fuel tank pressure and the atmospheric pressure can be prevented by adjusting the fuel tank pressure using a pressure regulating valve. Furthermore, an alarm mechanism is disposed on the shut-off device. This alarm mechanism is activated by air flowing through the pressure regulating valve and provides a warning that the pressure valve has been activated. Therefore, the user can determine from the alarm mechanism that the pressure regulating valve has been activated, enabling the pressure adjustment mechanism or the like mounted to the fuel tank to be quickly repaired or checked.

So long as the shut-off device constitutes means for closing the fuel path inside the inlet pipe, it may comprise a screw-on fuel cap or means for closing the fuel path while maintaining a seal. Furthermore, the shut-off device may be detachable from the inlet pipe or may be mounted to the inlet pipe in an integral, non-detachable fashion.

It is preferred that the pressure regulating valve of the present invention comprise a positive pressure valve or a negative pressure valve. It is particularly preferred that a negative pressure valve be used as the pressure regulating valve because such a valve will prevent damage to the fuel tank in the event of a large buildup of negative pressure therein.

It is preferred that the alarm mechanism comprise a whistle mechanism that emits a sound caused by the air flow that occurs if the pressure regulating valve is opened. In addition, by including a flow path forming member that guides the air flow from the whistle mechanism to the pressure regulating valve, the air flow that flows through the pressure regulating valve can be efficiently converted into sound energy. The whistle mechanism may include a reed that vibrates due to the air flow resulting from the opening action of the pressure regulating valve.

In a different preferred aspect of the present invention, the alarm mechanism includes a flow path forming member that guides outside air to the pressure regulating valve and a moving body that is disposed inside the flow path forming member and can move from a standby position to an alarm position, characterized in that the moving body moves from the standby position to the alarm position as a result of the air flowing within the flow path forming member when the pressure regulating valve opens, and the movement of the moving body to the alarm position can be visually recognized from the outside. According to the aspect, the moving body can be seen from the outside, enabling the activation of the pressure regulating valve to be reliably recognized. In the construction, a display window that permits the presence of the moving body at the alarm position to be recognized may be formed in the outer wall of the shut-off device.

A preferred aspect of the above alarm mechanism includes a positioning means that positions and fixes the moving body at the alarm position when it has moved to the alarm position. Through the construction, the alarm operation resulting from the movement of the moving body can be ensured. Furthermore, in the construction, the alarm mechanism may include a spring that pushes the moving body toward the standby position and may be constructed such that the moving body is stopped at the alarm position when it has move to the alarm position.

Another preferred aspect of the above alarm mechanism includes a fluid chamber that houses a display fluid, and the moving body may include a valve element that causes the display fluid to flow out from the fluid chamber when the moving body has moved from the standby position to the alarm position. The driver or other user can determine whether or not an alarm is present by viewing the display fluid through the display window when the pressure regulating valve has been opened. In the construction, the moving body may include a valve element that causes the display fluid to flow out from the fluid chamber when the moving body has moved from the standby position to the alarm position, as well as a pressure receiving unit that moves in tandem with the valve element and receives the differential pressure caused by the air flow resulting from the opening action of the pressure regulating valve, and reliable operation may be achieved by separating these two effects.

Another preferred aspect of the above alarm mechanism includes a moving body that moves in different directions due to the air flow resulting from the opening action of the negative pressure valve or the air flow resulting from the opening action of the positive pressure valve, a first alarm surface that indicates that the moving body has not moved, a second alarm surface that indicates that a negative pressure state is present, and a third alarm surface that indicates that a positive pressure state is present based on the movement of the moving body. In the way, warnings regarding either a negative pressure state or a positive pressure state may be given using a single moving body.

Still another preferred aspect of the above alarm mechanism includes a moving body that moves due to air flowing through the pressure regulating valve, a switch that turns ON and OFF based on the movement of the moving body, and a lamp that becomes illuminated when the switch is ON. The alarm mechanism may be realized via electrical display in the fashion.

Furthermore, yet another preferred aspect of the present invention comprises a fueling apparatus for a fuel tank that includes an inlet pipe having a fuel path that supplies fuel to the fuel tank and a pressure regulating valve that regulates the pressure in the fuel tank and is disposed in the inlet pipe, the fueling apparatus including an alarm mechanism that indicates that the pressure regulating valve has been activated due to the air flow resulting from the opening action of the pressure regulating valve. The alarm mechanism may be disposed in a fueling apparatus that is disposed separately from the shut-off device in the fashion.

A preferred aspect of the present invention includes a shut-off mechanism that is disposed at the opening of the inlet pipe and opens and closes the fuel path, characterized in that the pressure regulating valve is disposed such that it regulates the pressure of the fuel path on the side of the fuel tank that is tightly closed by the shut-off mechanism.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a cross-sectional view of a fuel cap pertaining to a first embodiment of the present invention;

FIG. 2 is an expanded cross-sectional view of the area around the pressure regulating valve.

FIG. 3 is an exploded cross-sectional view of the pressure regulating valve;

FIG. 4 shows the valve opening operation in a positive pressure;

FIG. 5 shows the valve opening operation in a negative pressure;

FIG. 6 is a cross-sectional view of an alarm mechanism pertaining to a second embodiment;

FIG. 7 is a cross-sectional view of a fuel cap pertaining to a third embodiment;

FIG. 8 shows the operation of the alarm mechanism of the third embodiment;

FIG. 9 is a cross-sectional view of an alarm mechanism pertaining to a variation of the third embodiment;

FIG. 10 shows the operation of the alarm mechanism of the variation of the third embodiment;

FIG. 11 is a cross-sectional view of an alarm mechanism pertaining to a fourth embodiment;

FIG. 12 shows the operation of the fourth embodiment;

FIG. 13 is a cross-sectional view of an alarm mechanism pertaining to a fifth embodiment;

FIG. 14 shows the operation of the fifth embodiment;

FIG. 15 is a cross-sectional view of an alarm mechanism pertaining to a sixth embodiment;

FIG. 16 shows the operation of the sixth embodiment;

FIG. 17 is a cross-sectional view of an alarm mechanism pertaining to a seventh embodiment;

FIG. 18 shows the operation of the seventh embodiment in a negative pressure;

FIG. 19 shows the operation of the seventh embodiment in a positive pressure;

FIG. 20 is a cross-sectional view of an alarm mechanism pertaining to an eighth embodiment;

FIG. 21 is a cross-sectional view of an automobile fuel tank fueling apparatus pertaining to a ninth embodiment;

FIG. 22 shows the fuel supply operation;

FIG. 23 shows an alarm mechanism; and

FIG. 24 is a cross-sectional drawing showing an automobile fuel tank fueling apparatus pertaining to a tenth embodiment.

### DESCRIPTION OF THE PREFERRED EMBODIMENTS

### A. First Embodiment

(1) Basic Construction of Fuel Cap (Shut-Off Device) 10

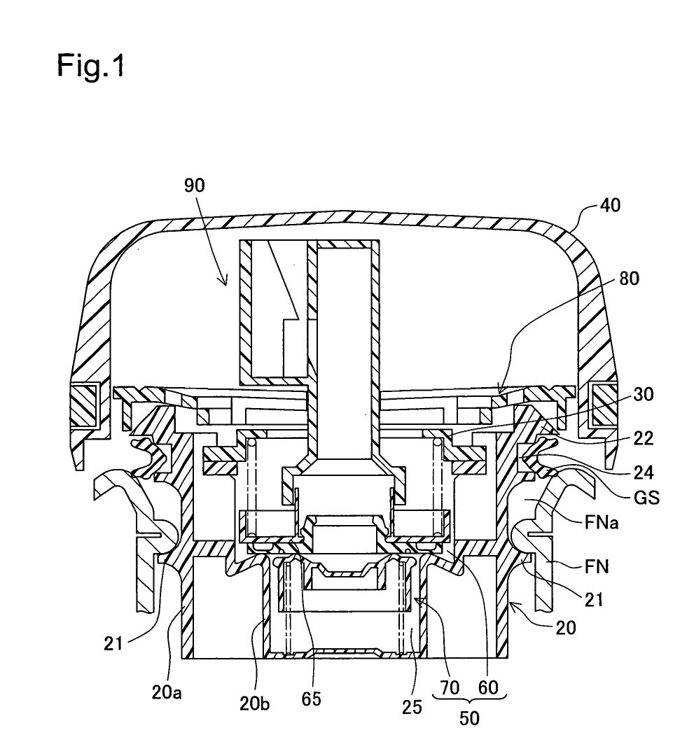

FIG. 1 is a cross-sectional view of a fuel cap 10 of a first embodiment of the present invention. In FIG. 1, the fuel cap 10 is mounted to a filler neck FN having a inlet opening (tank opening) FNa, by which fuel is supplied to a fuel tank not shown in the drawing, and includes a cap main body 20 made of a synthetic resin material such as polyacetal resin, a cover 40 that is mounted to the upper part of the cap main body 20 and has an operation member made of a synthetic resin material such as nylon, a spring support member 30 that closes off the top opening of the cap main body 20 and forms a valve chamber 25, a pressure regulating valve 50 housed in the valve chamber 25, a torque mechanism 80, an alarm mechanism 90 and a gasket GS that is mounted to the top outer circumference of the cap main body 20 and provides a seal between the cap main body 20 and the filler neck FN. The pressure regulating valve 50 comprises a positive pressure valve 60 and a negative pressure valve 70, and regulates the pressure in the fuel tank such that the pressure is maintained within a predetermined range. The alarm mechanism 90 is a mechanism that notifies the user of the activation state of the negative pressure valve 70.

The cap main body 20 includes a roughly outer tubular member 20a that has a cap engagement element 21 that engages with the inner circumference of the filler cap FN and a valve chest formation member 20b that forms from the bottom to the top of the outer tube 20a and forms the valve chamber 25. The valve chest formation member 20b and the top of the outer tube 20a form the valve chamber 25 by being covered by the spring support member 30 mounted to the top of the cap main body 20.

The gasket GS is externally mounted to the outer surface of a flange 22 at the upper portion of the cap main body 20. The gasket GS is disposed between a seal protector 24 of the flange 22 and the inlet opening FNa of the filler neck FN, and when the fuel cap 10 is secured onto the inlet opening FNa, the gasket GS pushes against the seal protector 24 to create a seal effect. When this occurs, the user feels a clicking sensation when a predetermined rotational torque is exceeded during the operation to close the fuel cap 10 via the torque mechanism 80, enabling the user to confirm that the fuel cap 10 is closed with a force at least equal to the predetermined rotational torque.

(2) Construction of Pressure Regulating Valve 50

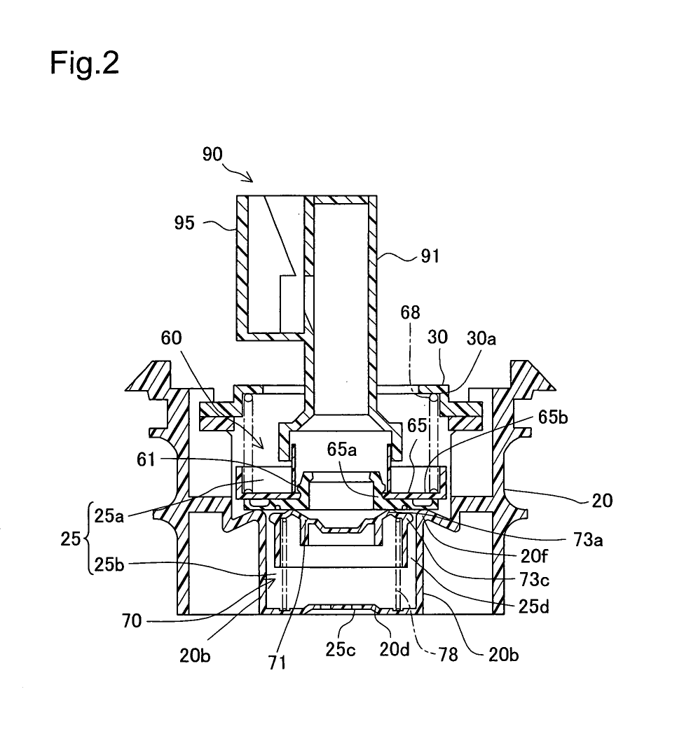

FIG. 2 is an expanded cross-sectional view of the area surrounding the pressure regulating valve 50. The pressure regulating valve 50 comprises the positive pressure valve 60 and the negative pressure valve 70. The positive pressure valve 60 is disposed in the upper chamber 25a of the valve chamber 25, while the negative pressure valve 70 is disposed in the lower chamber 25b. A first seat element 20f is formed between the upper chamber 25a and the lower chamber 25b at the part that is angled from the inside of the valve chest formation member 20b and a first valve flow path 25d is formed to face the first seat element 20f. The first valve flow path 25d passes through a connection hole 25c formed in the bottom part 20d, and the connection hole 25c is connected to the fuel tank via a filler pipe not shown in the drawing.

(2)-1 Construction of Positive Pressure Valve 60

The positive pressure valve 60 includes a positive pressure valve body 61 that opens and closes the first valve flow path 25d, a valve holding member 65, and a first spring 68 that is secured at one end to the spring support member 30 and applies force to the positive pressure valve body 61 in the closing direction via the valve holding member 65.

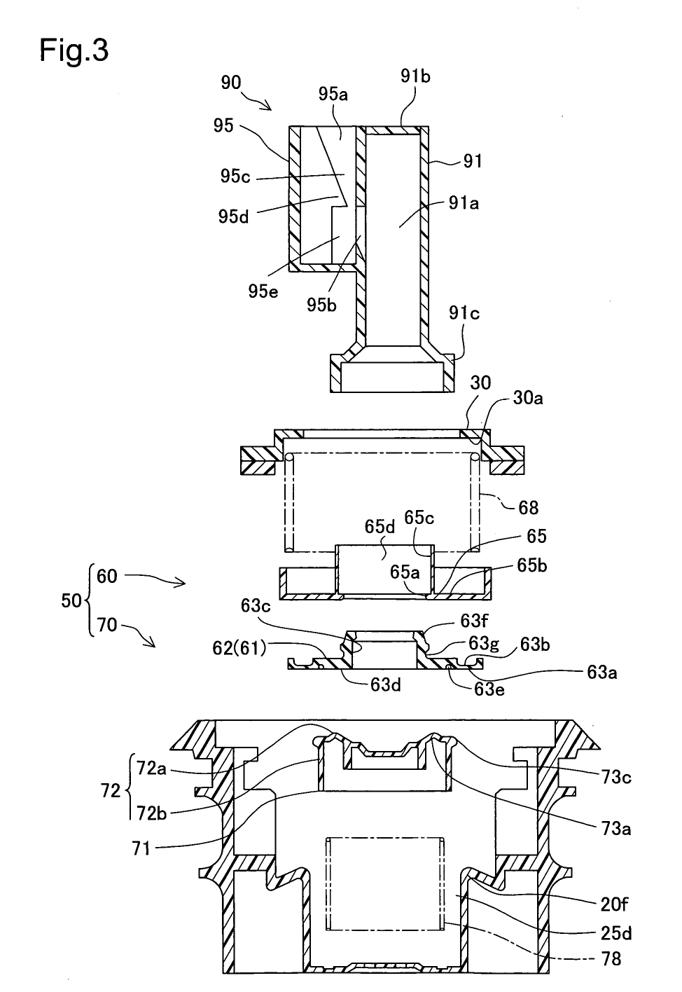

FIG. 3 is an exploded cross-sectional view of the pressure regulating valve 50. The positive pressure valve body 61 includes a disk-shaped positive pressure valve main body 62 made of fluorocarbon rubber or the like, and through holes and protrusions that serve as valves are formed in the positive pressure valve main body 62. In other words, a seat element 63a that closes the first valve flow path 25d by sitting on the first seat element 20f is formed on the positive pressure valve main body 62. The seat element 63a is thin due to the formation of an circular recess 63b on the top surface of the outer circumference of the positive pressure valve main body 62, which increases the seal effect by causing the seat element 63a to deform when the seat element 63a sits on the first seat element 20f. A second valve flow path 63c connected to the first flow path 25d is formed through the center portion of the positive pressure valve main body 62. A second seat element 63d is formed on the area of the bottom surface of the positive pressure valve main body 62 that faces the second valve flow path 63c. The second seat element 63d serves as a seating surface for the negative pressure valve 70 as described below. An circular groove 63e on the bottom surface of the positive pressure valve main body 62 is formed at the inner circumferential side of the circular recess 63b. The circular groove 63e is a groove that allows easy deforming when the positive pressure valve body 61 is opened.

A cylindrical engaging part 63f is disposed on the center of the positive pressure valve body 61 such that the cylindrical engaging part 63f surrounds the second valve flow path 63c. A side support groove 63g is formed on the side of the engaging part 63f, and the positive pressure valve body 61 is mounted to the valve holding member 65 via the insertion of the valve holding member 65 in an engaging hole 65a. A spring support part 65b is formed on the top surface of the valve holding member 65, and the spring support part 65b supports one end of the first spring 68. The first spring 68 extends between the spring support part 65b and the support member 30 and is supported by the support part 30a of the spring support member 30. A cylinder 65c that forms a flow path 65d connected to the second valve flow path 63c is disposed on and protrudes from the valve holding member 65.

(2)-2 Construction of Negative Pressure Valve 70

As shown in FIG. 2, the negative pressure valve 70 includes a negative pressure valve body 71 made of resin, as well as a second spring 78 that extends between the negative pressure valve body 71 and the bottom part 20d and applies force to the negative pressure valve body 71.

As shown in FIG. 3, the negative pressure valve body 71 includes a cup-shaped negative pressure valve main body 72 comprising an upper wall plate 72a and a cylindrical side wall 72b that protrudes from the outer circumference of the upper wall plate 72a, and protrusions or the like that serve as valves are formed on the negative pressure main unit 72. A round conical seat element 73a that closes the second valve flow path 63c by sitting on the second seat element 63d of the positive pressure valve body 61 is formed on the upper wall plate 72a of the negative pressure valve main body 72. In addition, an annular protrusion 73c is formed at the top of the side wall 72b at a position facing the first valve flow path 25d. The annular protrusion 73c forms a restriction that reduces the flow path area of the first valve flow path 25d when the negative pressure valve body 71 is closed and increases the flow path area of the first valve flow path 25d when the negative pressure valve body 71 moves together with the positive pressure valve body 61 in tandem with the opening thereof.

(3) Operation of Pressure Regulating Valve 50

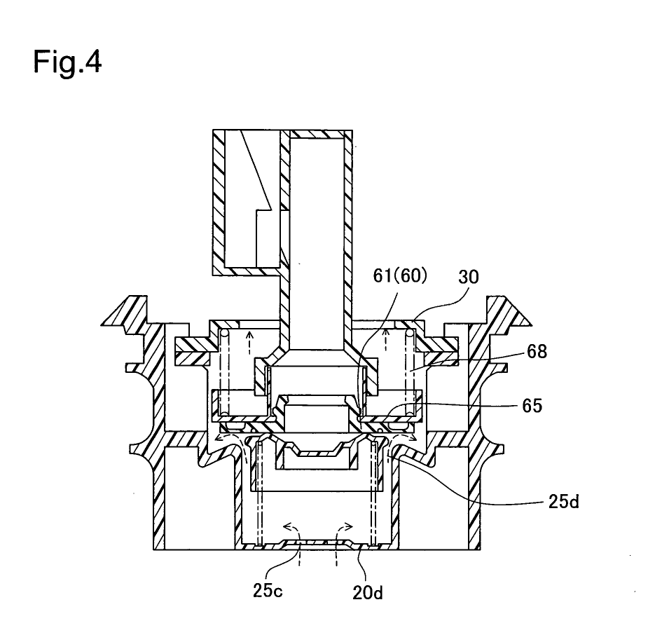

In the construction, adjustment of the pressure inside the fuel tank via the positive pressure valve 60 is performed as described below. First, when the pressure inside the fuel tank increases above a first pressure level while the fuel cap 10 shown in FIG. 1 is mounted to the filler neck FN, the positive pressure valve 60 moves to the state shown in FIG. 4, i.e., the positive pressure valve body 61 and valve holding member 65 rise in opposition to the spring force of the first spring 68, such that the interior of the fuel tank becomes connected to the outside air through the filler pipe, the connection hole 25c of the bottom part 20d, the first valve flow path 25d, the gap around the positive pressure valve body 61 and the through holes in the spring support member 30, eliminating the pressure in the fuel tank. When the differential pressure on the positive pressure valve body 61 falls below the spring force exerted by the first spring 68 as a result of the connection to the atmosphere, the positive pressure valve body 61 is pushed down into the closing position by the spring force of the first spring 68, as shown in FIG. 2. In this way, the positive pressure valve body 61 is opened and closed such that the pressure in the fuel tank does not exceed the first pressure level.

If the pressure in the fuel tank falls below a second pressure level, on the other hand, the negative pressure valve body 71 moves downward against the force exerted by the second spring 78 and separates from the second seat element 63d of the positive pressure valve body 61. When this occurs, the positive pressure valve body 61 is sitting on the first seating element 20f, and in order to maintain the state, a path is formed between the negative pressure valve body 71 and the positive pressure valve body 61. As a result, the fuel tank becomes connected to the atmosphere via a path in the alarm mechanism 90 described below, the flow path 65d in the cylinder 65c of the valve holding member 65, the second valve flow path 63c, the first valve flow path 25d, and the connection hole 25c of the bottom part 25d, thereby eliminating the negative pressure state in the fuel tank. When the differential pressure exerted on the negative pressure valve body 71 thereafter falls below the force exerted by the second spring 78, the negative pressure valve body 71 closes.

(4) Alarm Mechanism 90

In FIG. 2, the alarm mechanism 90 is a whistle mechanism that emits a sound due to the air flow that occurs when the negative pressure valve 70 is opened, and is disposed axially at the upper part of the fuel cap 10 and upstream from the negative pressure valve 70. The alarm mechanism 90 includes a flow path forming member 91 disposed in the center of the fuel cap 10 and a whistle mechanism 95 integrally formed on the side of the flow path forming member 91.

As shown in FIG. 3, the flow path forming member 91 is a cylinder having a flow path 91a, the upper part of which is closed off by a stopper 91b and the lower part comprises an expansion part 91c that expands the flow path 91a, and is connected to the top part of the cylinder 65c of the valve holding member 65 via the expansion part 91c. The whistle mechanism 95 includes an air flow path 95c that connects an intake inlet 95a to the flow path 91a via an outlet 95b formed in the flow path forming member 91. A resonating aperture 95d that restricts the amount of air flow to the outlet 95b is formed in the air flow path 95c, and the back side of the resonating aperture 95d comprises a resonance chamber 95e.

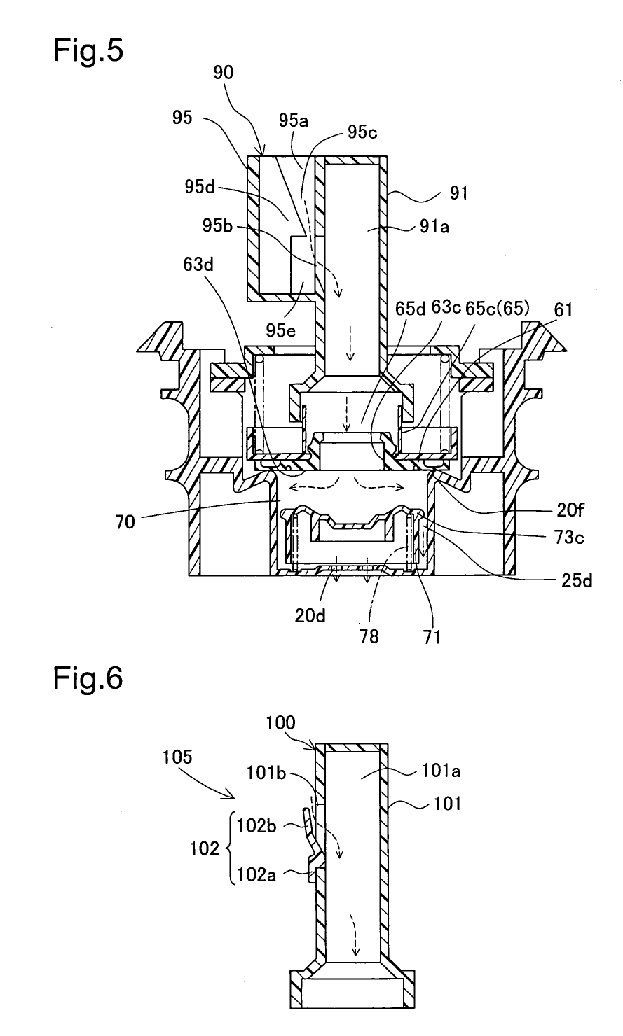

The operation of the alarm mechanism 90 is described. As shown in FIG. 5, when the pressure in the fuel tank falls below the second pressure level and the valve opens, outside air flows inside the air flow path 95c from the intake inlet 95a of the alarm mechanism 90 and is narrowed by the resonating aperture 95d, whereupon outside air enters both the flow path 91a from the outlet 94b and the resonance chamber 95e. Outside air further enters the fuel tank from the fuel path 91a via the flow path 65d and the negative pressure valve 70. When this occurs, the alarm mechanism 90 emits a sound due to the increase in air flow speed caused by the resonating aperture 95d and the resonating action of the air flowing into the resonance chamber 95e.

Therefore, the user can learn via the sound emitted by the alarm mechanism 90 when the negative pressure valve 70 is activated that the pressure regulating valve 50 has been activated as a backup to the pressure adjustment mechanism of the fuel tank, enabling the pressure adjustment mechanism to be promptly fixed or checked.

Furthermore, because the alarm mechanism 90 is activated by the air flowing through the negative pressure valve 70, no wiring is required and the construction is simpler than in the case where an electrical sensor is used.

### B. Second Embodiment

FIG. 6 is a cross-sectional view of an alarm mechanism 100 pertaining to a second embodiment. The embodiment is a variation of the first embodiment and uses as a whistle mechanism 105 a reed that vibrates due to air flow. A flow path 101a that forms a resonance chamber is formed in a flow path forming member 101. An intake inlet 101b that connects the flow path 101a to the outside is formed in the side wall of the flow path forming member 101. One end of a reed 102 is affixed to a side of the opening of the intake inlet 101b. In other words, the lower end portion 102a of the reed 102 is affixed to a side of the opening of the intake inlet 101b, and a vibrating part 102b of the reed 102 covers the intake inlet 101b in a half-open state. According to the embodiment, when the fuel tank pressure falls below the second pressure level and the negative pressure valve 70 opens as a result, outside air enters the flow path 101a via the gap between the reed 102 and the intake inlet 101b. Accordingly, sound is emitted due to the resonance caused by the vibration of the reed 102 and the resonance chamber formed by the flow path 101a, enabling the user to receive the warning.

### C. Third embodiment

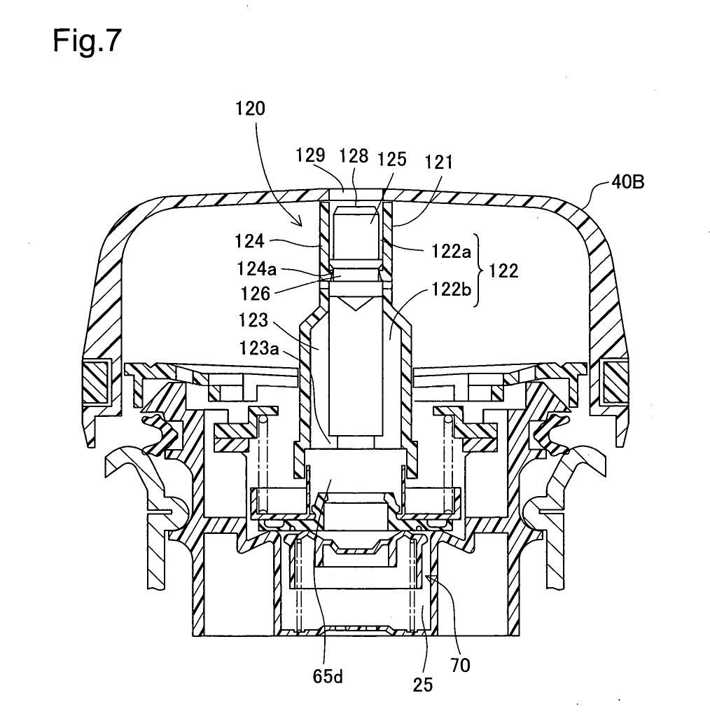

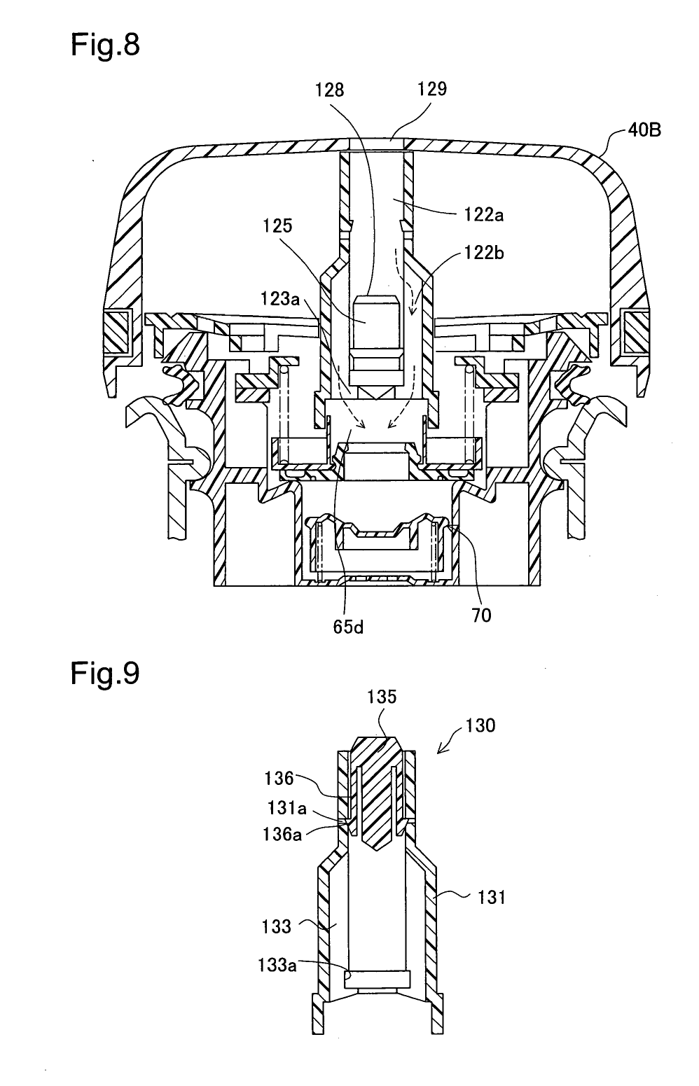

FIGS. 7 and 8 are cross-sectional views of a fuel cap pertaining to a third embodiment. FIG. 7 shows the state where the negative pressure valve 70 is not activated, while FIG. 8 shows the state where the negative pressure valve 70 is activated. The alarm mechanism 120 of the embodiment is characterized in that the alarm mechanism 120 provides a visual warning to the user indicating the existence of a negative pressure state. The alarm mechanism 120 includes a flow path forming member 121 and a moving body 125. The flow path forming member 121 is a cylinder that expands at the lower part thereof and has a flow path 122. The flow path 122 includes a central main flow path 122a and a side flow path 122b that is formed around the outer circumference of the lower portion of the main flow path 122a. The side flow path 122b is formed between multiple flow path forming ribs 123 that extend in the axial direction and protrude from the inner wall of the flow path forming member 121. The wall surface of the upper part of the main flow path 122a and the flow path forming ribs 123 serve to guide the moving body 125 in the axial direction. Moreover, an engaging tip 123a that regulates the movement of the moving body 125 is formed at the bottom end of the flow path forming rib 123.

The moving body 125 has a round pillar configuration and is movably supported such that it can move within the main flow path 122a. The bottom end part of the moving body 125 is formed in a circular conical configuration. The top part of the moving body 125 comprises a display part 128. A display window 129 that is installed in a cover 40B that faces the display part 128 and is covered by transparent resin is disposed in the center part of the cover 40B. The user can observe through the display window 129 whether the display part 128 of the moving body 125 is at the standby position shown in FIG. 7 or the alarm position shown in FIG. 8.

The moving body 125 is supported in the upper part of the main flow path 122a at the standby position shown in FIG. 7, and an elastic engaging piece 124 formed on the flow path forming member 121 and an engaging recess that is formed in the outer circumference of the moving body 125 and engages with the elastic engaging piece 124 serves as the means of such support. In other words, the elastic engaging piece 124 comprises a cantilever and an engaging claw 124a is formed at the distal end thereof, and the moving body 125 is held at the standby position of the main flow path 122a via the engagement between the engaging claw 124a and the engaging recess 126.

The operation of the alarm mechanism 120 will now be described. When the fuel tank pressure falls below the second pressure level and the negative pressure valve 70 opens, the difference in pressure between the top and bottom surfaces of the moving body 125 causes the application of downward force thereon. The moving body 125 is maintained in the standby position via the engagement of the engaging claw 124a of the elastic engaging piece 124 with the engaging recess 126, but when the downward force exerted on the moving body 125 increases, the elastic engaging piece 124 separates from the engaging recess 126 via elastic deformation, causing the moving body 125 to move downward. The moving body 125 then stops due to the contact between the bottom end thereof and the stopping end 123a (this state is shown in FIG. 8). When this occurs, the outside air enters the fuel tank via the negative pressure valve 70 from the main flow path 122a through the side flow path 122b and the flow path 65d.

When the moving body 125 is at the standby position as shown in FIG. 7, the display part 128 faces the display window 129, indicating that the negative pressure valve 70 has not been activated, but when the moving body 125 has moved to the alarm position as shown in FIG. 8, the display part 128 is located away from the display window 129, indicating that the negative pressure valve 70 has been activated. Therefore, by observing the state of the display window 129 when opening or closing the fuel cap, such as when filling the tank, the user can see that the negative pressure valve 70 operating as a backup for the pressure adjustment mechanism of the fuel tank has been activated, enabling the pressure adjustment mechanism to be quickly checked.

In addition, once the moving body has moved to the alarm position, it remains there, enabling the alarm mechanism 120 to provide reliable notification that the pressure adjustment mechanism needs to be checked.

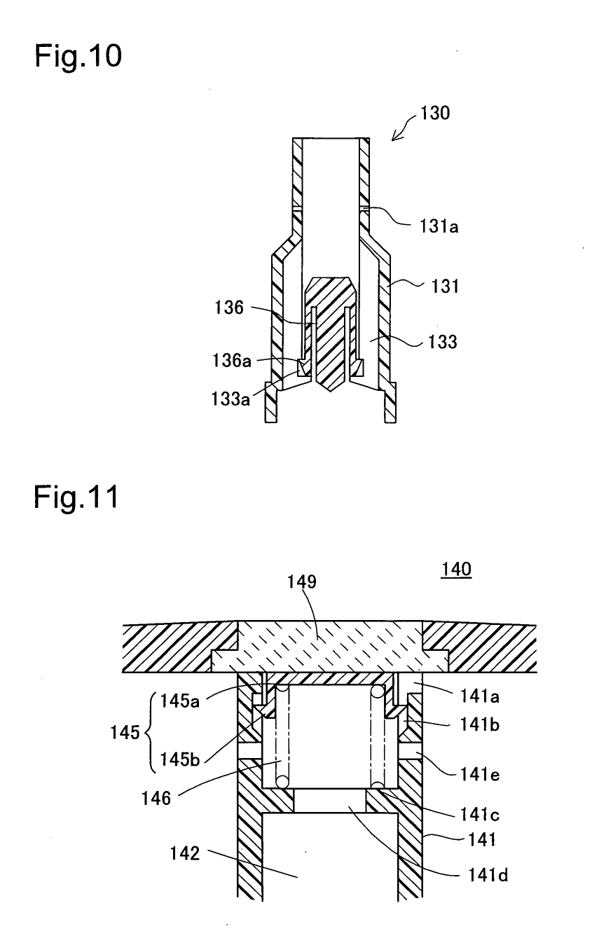

FIGS. 9 and 10 are cross-sectional views of an alarm mechanism 130 pertaining to a variation of the third embodiment shown in FIG. 7. FIG. 9 shows the state where the negative pressure valve has not been activated, while FIG. 10 shows the state where the negative pressure valve has been activated. The variation is characterised by the construction used therein to stop the moving body 135 in the flow path forming member 131. An elastic engaging piece 136 having an engaging claw 136a at the distal end thereof is disposed at the outer circumference of the moving body 135. The engaging claw 136a holds the moving body 135 at the standby position by engaging with the engaging hole 131a formed in the flow path forming member 131. In addition, an engaging recess 133a that engages with the engaging claw 136a at the alarm position is formed at the bottom of each flow path forming rib 133. Accordingly, various constructions may be adopted for the positioning means that supports the moving body 135 inside the flow path forming member 131.

### D. Fourth Embodiment

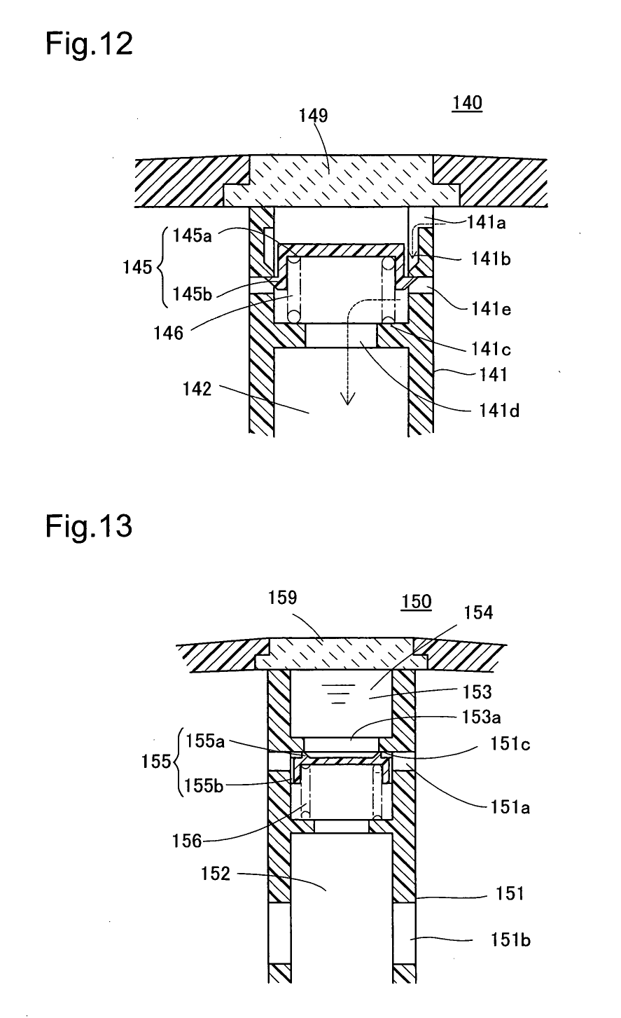

FIGS. 11 and 12 are cross-sectional views of an alarm mechanism 140 pertaining to a fourth embodiment. FIG. 11 shows the state where the negative pressure valve has not been activated, while FIG. 12 shows the state where the negative pressure valve has been activated. The embodiment is characterised in that a valve mechanism is used as the alarm mechanism 140. The alarm mechanism 140 includes a flow path forming member 141 having a flow path 142 connected to the negative pressure valve, a moving body 145 disposed inside the flow path 142, and a spring 146 that exerts force on the moving body 145. The moving body 145 includes a top surface 145a and an elastic engaging piece 145b that is formed such that it extends downward from the outer circumference of the top surface 145a. The elastic engaging piece 145b is formed such that it is guided by a guide groove 141b and engages with an engaging hole 141e. The spring 146 supported by a spring support part 141c exerts upward force on the moving body 145 such that the top surface of the top surface part 145a faces the bottom surface of the display window 149.

In the alarm mechanism 140, when the fuel tank enters the negative pressure state and the negative pressure valve opens, outside air flows from the through hole 141a via the flow path 142, the gap around the outer circumference of the moving body 145 and the through hole 141d. As a result, a pressure differential occurs between the top surface part 145a and the bottom surface of the moving body 145, causing downward force to be exerted on the moving body 145. While the moving body 145 is maintained at the standby position by the force exerted by the spring 146, when the downward force exerted on the moving body 145 exceeds the force exerted by the spring 146, the moving body 145 moves downward. The moving body 145 is then stopped due to the engagement between the elastic engaging piece 145b and the engaging hole 141e (the state shown in FIG. 12). As a result, because the top surface of the moving body 145 is separated from the display window 149, the display in the display window 149 changes, enabling the activation of the negative pressure valve to be recognised. According to the embodiment, because force is exerted on the moving body 145 by the spring 146, the operation to switch the state of the moving body 145 from the non-activated state to the activated state can be reliably performed.

### E. Fifth Embodiment

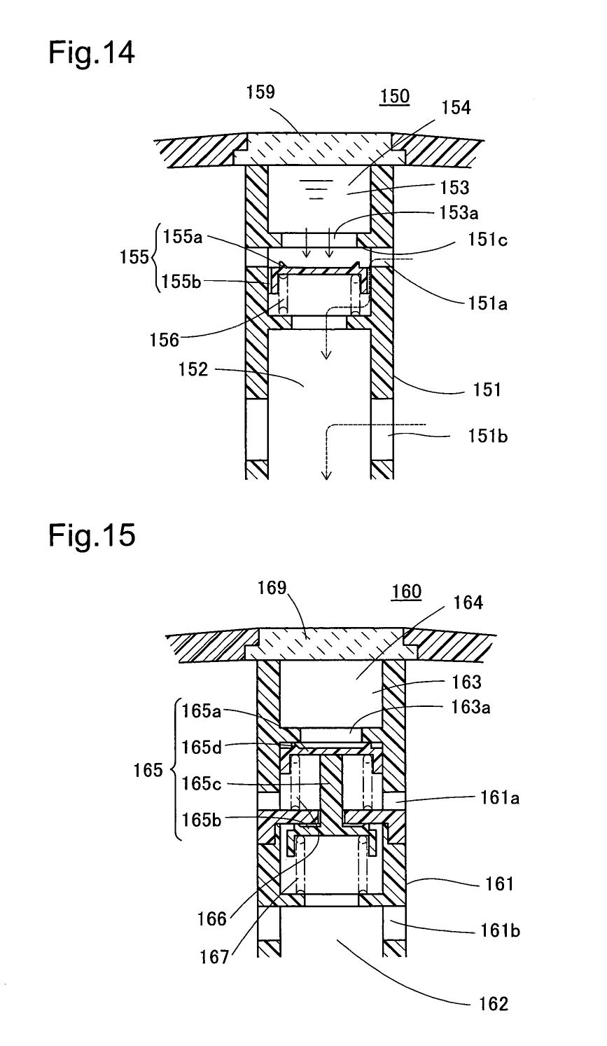

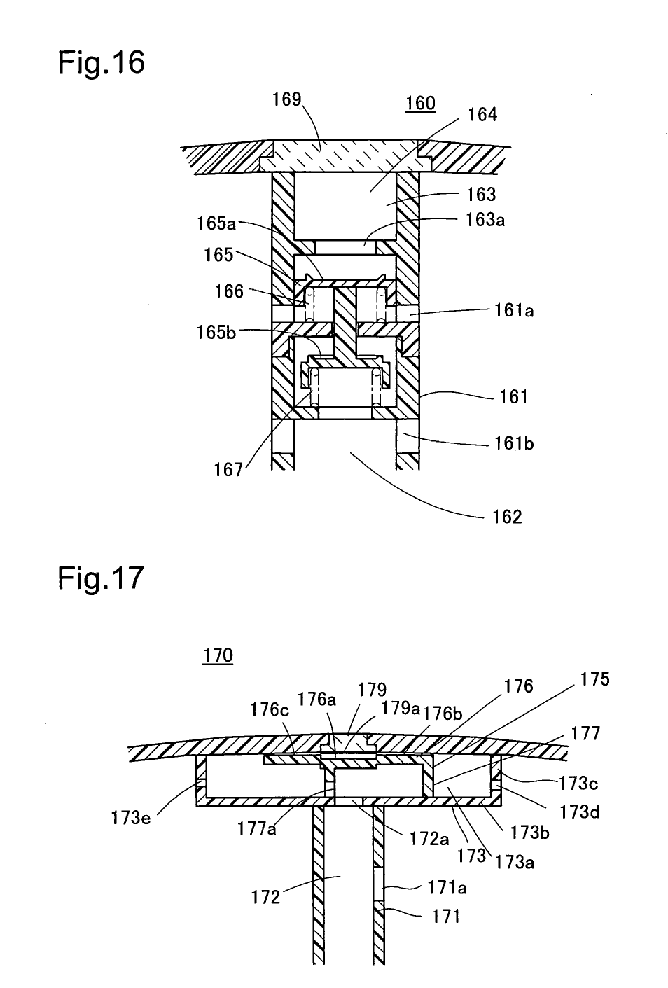

FIGS. 13 and 14 are cross-sectional views of an alarm mechanism pertaining to a fifth embodiment. The embodiment is charactrised in that the means of notification via the alarm mechanism 150 is implemented via the outflow of a fluid body. The alarm mechanism 150 includes a fluid chamber 153 that is disposed in the upper area of the flow path forming member 151 and houses a display fluid 154, a moving body 155 that serves as a valve to open and close an outflow path 153a disposed below the fluid chamber 153, and a spring 156 that exerts upward force on the moving body 155. A colored fluid or powder may be used as the display fluid.

In the alarm mechanism 150, when the fuel tank interior enters a negative pressure state and the negative pressure valve opens, air flows in from the connecting path 151b via the flow path 152, as well as from the connecting path 151a through the aperture 155b at the outer circumference of the moving body 155 and the flow path 152. As a result, the moving body receives downward force based on the difference in the upward and downward pressures exerted on the moving body 155 and moves against the spring force of the spring 156, causing the seat element 155a to separate from the seal element 151c, thereby opening the outflow path 153a. As a result, the display in the display window 159 changes by virtue of the fact that the display fluid 154 in the fluid chamber 153 flows out from the outflow path 153a to the flow path 152.

### F. Sixth Embodiment

FIG. 15 is a cross-sectional view of an alarm mechanism 160 pertaining to a sixth embodiment. The embodiment is a variation of the fifth embodiment and is characterised by the construction of its moving body 165. In other words, the moving body 165 is a two-layer valve mechanism comprising a valve element 165a and a pressure-receiving element 165b that are connected together by a linking rod 165c, force is exerted on the valve element 165a by a spring 166, and force is exerted on the pressure-receiving element 165b by a spring 167. A seat element 165d is formed on the valve element 165a and contains a display fluid 164 inside a fluid chamber 163. The pressure-receiving element 165b receives the difference in air flow pressure when a negative pressure state is present. In the alarm mechanism 160, when the fuel tank interior enters a negative pressure state and the negative pressure valve opens, air flows in from the connecting path 161a of the flow path forming member 161 via the flow path 162, as well as from the connecting path 161b through the gap around the outer circumference of the linking rod 165c and the flow path 162. As a result, based on the difference in pressures exerted on the pressure-receiving element 165b, the moving body 165 moves against the spring force exerted by the springs 166, 167, thereby opening the outflow path 163a. Consequently, the display in the display window 169 changes by virtue of the fact that the display fluid 164 in the fluid chamber 163 flows out to the flow path 162.

### G. Seventh Embodiment

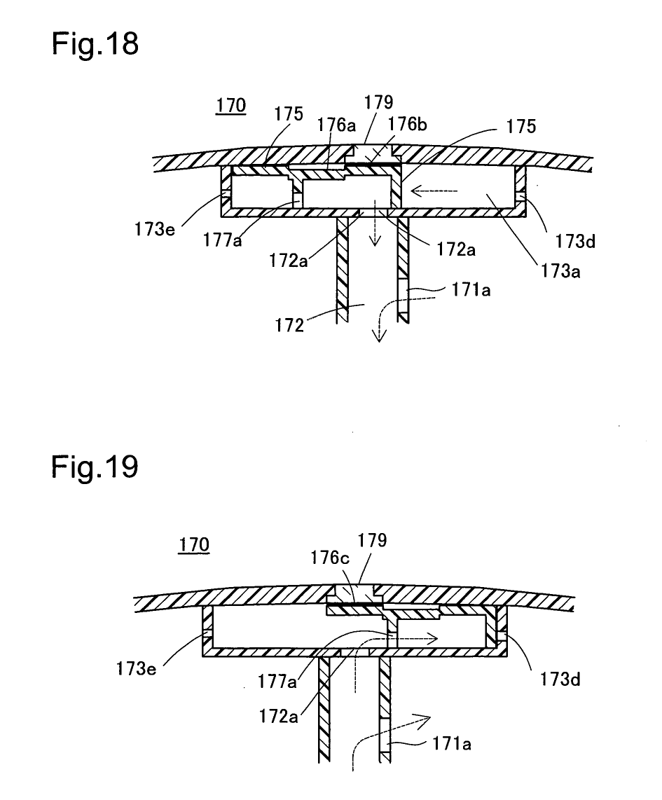

FIGS. 17 through 19 are cross-sectional views of an alarm mechanism 170 pertaining to a seventh embodiment. FIG. 17 shows the state where the pressure regulating valve has not been activated, FIG. 18 shows the state where the negative pressure valve has been activated, and FIG. 19 shows the state where the positive pressure valve has been activated. The embodiment is characterised in that an alarm is issued not only when the negative pressure valve has been activated, but also when the positive pressure valve has been activated. The alarm mechanism 170 includes a flow path forming member 171 connected to the valve flow path of the pressure regulating valve, a valve housing 173 having a valve chamber 173a, and a moving body 175 slidably housed in the valve housing 173. A flow path 172 is connected to the alarm mechanism 170 via a through hole 172a formed in the lower center part of the valve housing 173. The valve housing 173 includes a bottom wall 173b and a side wall 173c, and the valve chamber 173a is formed by these walls and the top surface of the cover piece. The valve chamber 173a is connected to the outside by through holes 173d and 173e formed in the valve housing 173. The moving body 175 comprises a top surface part 176 and a side wall 177. The top surface part 176 includes a first alarm surface 176a comprising a small centrally-located indentation and second and third alarm surfaces 176b and 176c, which are formed such that they face a display sheet 179a applied to a display window 179 in accordance with the position of the moving body 175. When the display sheet 179a faces the first alarm surface 176a, because there is a gap therebetween, the transparent color of the display window 179 is visible due to the diffused reflection of the display seat 179a, while where the display sheet 179a faces the second alarm surface is 176b or the third alarm surface 176c, because the display sheet 179a is pressed closely to the alarm surface, the color thereof is visible. Furthermore, a through hole 177a is formed in the side wall 177 of the moving body 175, and air flow occurs between the outside and the valve chamber 173a via The through hole 177a.

In the alarm mechanism 170, when the fuel tank interior enters a negative pressure state and the negative pressure valve opens, air flows in from the outside via the through hole 173d, the valve chamber 173a, the through hole 172a and the flow path 172, as shown in FIG. 18, as well as to the flow path 172 via the connecting path 171a. As a result, leftward force (in the drawing) is applied to the moving body 175 based on the difference in pressures, the moving body 175 moves as shown in FIG. 18, and the second alarm surface 176b comes to face the display window 179. Consequently, an alarm indicating the activation of the negative pressure valve is issued. On the other hand, where the fuel tank interior enters a positive pressure state and the positive pressure valve opens, air flows out from the flow path 172 via the through holes 172a, 177a and 173d. as well as via the connecting path 171a. As a result, rightward force (in the drawing) is applied to the moving body 175 based on the difference in pressures exerted thereon, the moving body 175 moves as shown in FIG. 19, and the third alarm surface 176c comes to face the display window 179. Consequently, an alarm indicating the activation of the positive pressure valve is issued. Accordingly, the activation of both the positive pressure valve and the negative pressure valve can be display using a single moving body 175.

### H. Eighth Embodiment

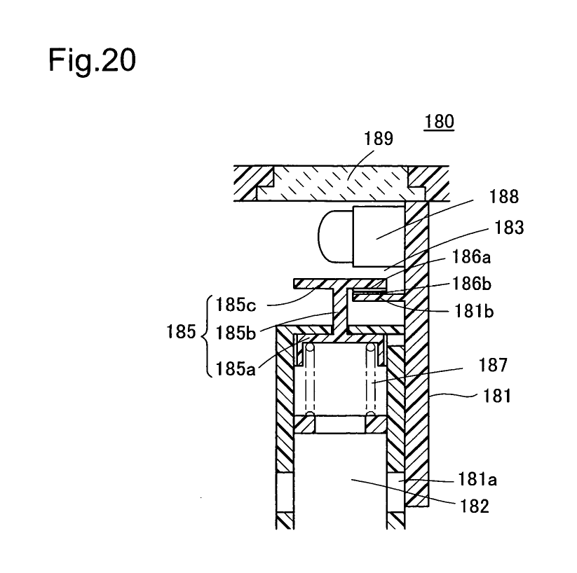

FIG. 20 is a cross-sectional view of an alarm mechanism pertaining to an eighth embodiment. The eighth embodiment is characterised in that the alarm is issued via electrical display. The alarm mechanism 180 includes in a flow path forming member 181 a switch 183 that closes upon the activation of the negative pressure valve and a light-emitting lamp that becomes illuminated upon the closing of the switch 183. The switch 183 includes a moving body 185, a spring 187, a traveling contact 186a and a fixed contact 186b. The moving body 185 includes a moving main body 185a that receives spring force from the spring 187 and a top surface part 185c that is linked to the top center part of the moving main body 185a via a linking rod 185b. The traveling contact 186a is mounted to the bottom surface of the top surface part 185c. In addition, the fixed contact 186b is fixed to the top surface of a fixed protrusion 181b that protrudes from the inner wall of the flow path forming member 181 with a predetermined gap between the fixed contact 186b and the traveling contact 186a.

In the alarm mechanism 180, when the fuel tank interior enters a negative pressure state and the negative pressure valve opens, air flows in from the connecting path 181a of the flow path forming member 181 via the flow path 182, and outside air flows in through the gap around the outer circumference of the linking rod 185b and the flow path 182. As a result, based on the difference in pressures exerted on the moving main body 185a of the moving body 185, the moving body 185 moves downward in opposition to the spring force of the spring 187. The traveling contact 186a makes contact with the fixed contact 186b due to the movement of the moving body 185, activating a switching circuit not shown in the drawing, and the light-emitting lamp is thereby illuminated. In this way, the display in the display window 189 changes.

### I. Ninth Embodiment

(1) Basic Construction and Opening/Closing Operation of Fueling Apparatus

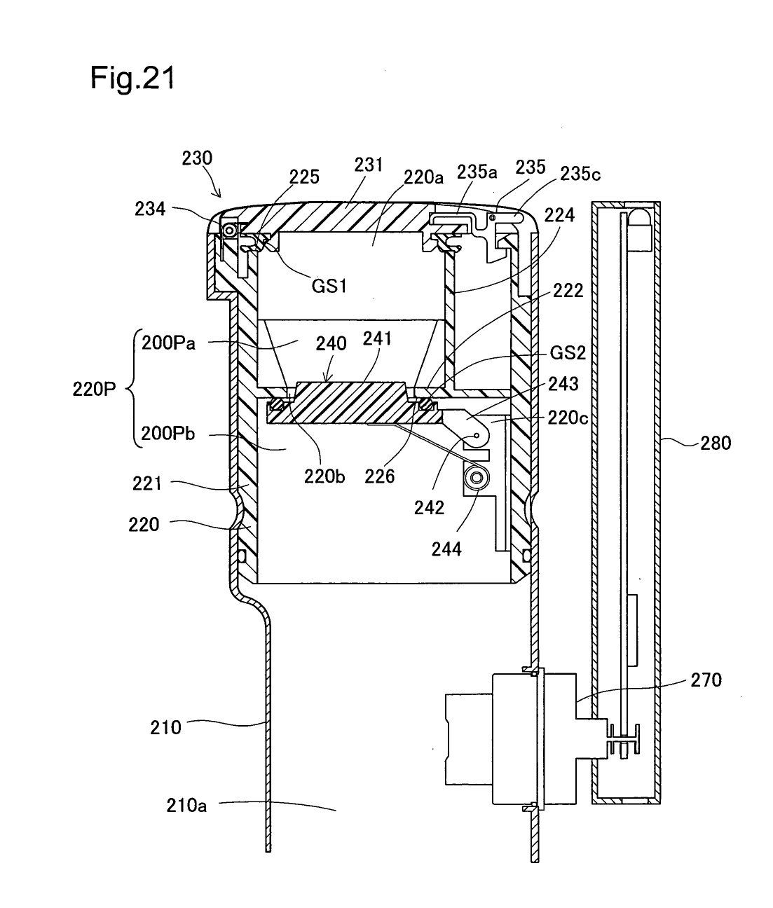

FIGS. 21 through 23 show a fueling apparatus for a fuel tank equipped with an alarm mechanism pertaining to a ninth embodiment. The embodiment comprises a fueling apparatus that enables fuel to be supplied without removing the fuel cap from the inlet pipe, and includes an alarm mechanism 280 that provides a warning regarding an abnormality in a pressure regulating valve 270. The fueling apparatus includes an inlet pipe 210 comprising a tube 212 and a path forming body 220 that forms a fuel path 220P disposed inside the tube 212, a first shut-off mechanism 230 that opens and closes an inlet opening 220a formed in the upper area of the path forming body 220, and a second shut-off mechanism 240 that opens and closes a seal opening 220b comprising a narrowed portion of the fuel path 220P inside the path forming body 220. With the fueling apparatus, the respective openings via the first shut-off mechanism 230 and the second shut-off mechanism 240 are opened and fuel is supplied using a fuel gun. The construction of each of the components thereof will be described below.

The path forming body 220 includes an outer tube 221 having the fuel path 220P, a party wall 222 that protrudes from the inner wall of the outer tube 221 toward the center thereof, and a party cylinder 224 that partitions off a portion of an opening-side path 220Pa. The party wall 222 constricts the area of the fuel path 220P by dividing it into the opening-side path 220Pa and a tank-side path 220Pb.

The first shut-off mechanism 230 includes a first shut-off member 231 rotatably supported at the top of the outer tube 221 and a first spring 234 that applies force to the first shut-off member 231 in the direction of opening. A clamp 235 that maintains the first shut-off member 231 in the closed state against the force exerted by the first spring 234 in the opening direction is formed at the other end of the first shut-off member 231. A gasket GS1 is mounted to the bottom of the first shut-off member 231.

The second shut-off mechanism 240 is an always-closed shutter disposed in the fuel path 220P at a position closer to the fuel tank than the first shut-off mechanism 230, and is formed so as to open the seal opening 220b when it is pressed by a fuel gun. The second shut-off mechanism 240 includes a second shut-off member 241, a support shaft 242, a mounting member 243 and a second spring 244. In other words, the second shut-off member 241 is constructed such that it is rotatably supported on the mounting member 243 by the support shaft 242, and closes the seal opening 220b of the path forming body 220 due to the spring force exerted by the second spring 244. A gasket GS2 is mounted to the outer circumference of the second shut-off member 241.

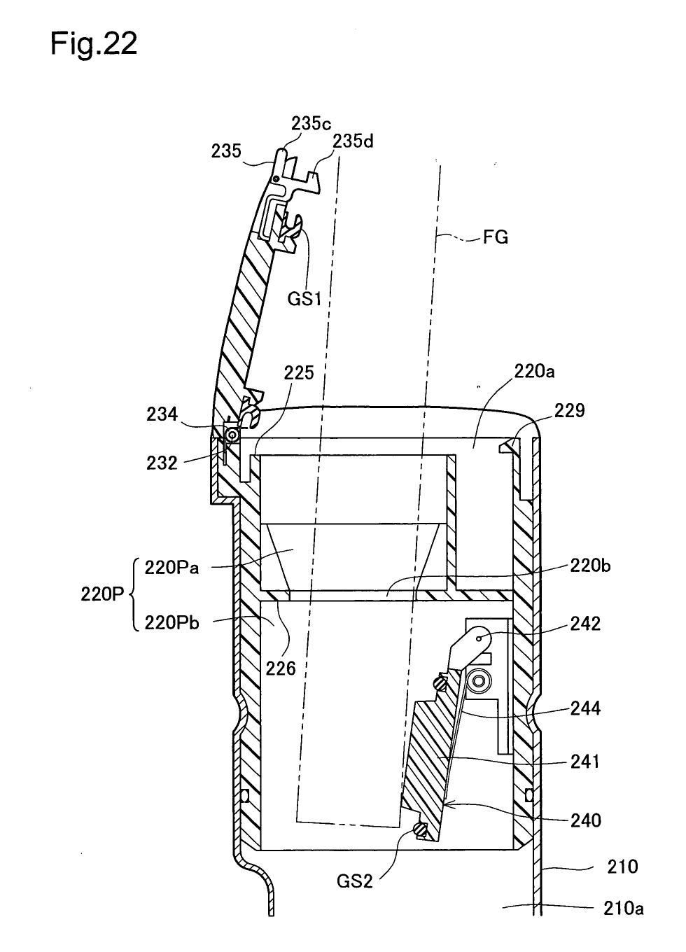

The opening/closing operation of the fueling apparatus will now be described. As shown in FIG. 21, from the state in which the first shut-off mechanism 230 is closed, the handle 235c of the clamp 235 is pressed downward, causing the arm 235a to rotate. As a result, the engaging claw 235d separates from the engaged claw 229, the first shut-off member 230 rotates due to the spring force of the first spring 234, and the inlet opening 220a is opened, as shown in FIG. 22. Also as shown in FIG. 22, the fuel gun FG is inserted into the fuel path 220P via the inlet opening 220a, the tip of the fuel gun FG is inserted as far as the seal opening 220b, and the top surface of the second shut-off member 241 is pressed by the tip of the fuel gun FG. As a result, the second shut-off member 241 rotates around the support shaft 242 in opposition to the spring force of the second spring 244, opening the seal opening 220b. The fuel gun is further inserted, and fuel is supplied to the fuel tank from the fuel gun via the tank-side path 220Pb and the fuel path 210a inside the inlet pipe 210. When fuel supply is completed and the fuel gun FG is removed, the seal opening 220b is closed by the second shut-off member 241 due to the spring force exerted by the second spring 244. When the first shut-off member 231 is caused to revolve around the pivot 232 through force applied on the first shut-off member 231 in the closing direction, the engaging claw 235d of the clamp 235 engages with the engaged claw 229, thereby causing the first shut-off member 231 to close the inlet opening 220a.

(2) Alarm Mechanism 280

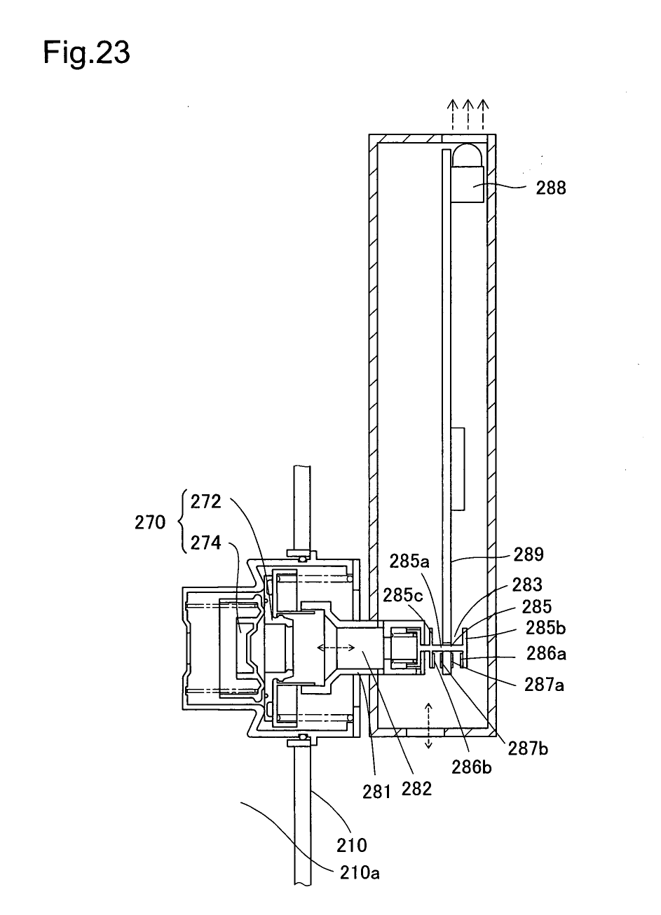

In FIG. 23, the fueling apparatus includes a pressure regulating valve 270 that is mounted to the side wall of the inlet pipe 210 and regulates the pressure in the fuel path 210a, as well as an alarm mechanism 280 that provides a warning of the activation of the pressure regulating valve 270. The pressure regulating valve 270 differs from the pressure regulating valve 50 of the first embodiment in that it is disposed at a 90° relative thereto, but the construction and operation are otherwise identical to those of the pressure regulating valve 50.

In other words, the pressure regulating valve 270 comprises a positive pressure valve 272 and a negative pressure valve 274. The positive pressure valve 272 permits air to flow to the outside when the pressure in the tank interior reaches positive pressure that equals or exceeds a predetermined level, while the negative pressure valve 274 regulates the tank interior pressure to a predetermined range by guiding outside air to the fuel tank interior when the fuel tank interior pressure reaches a negative pressure that is equal to or lower than a predetermined pressure level relative to outside air.

The alarm mechanism 280 is a variation of the alarm mechanism pertaining to the eighth embodiment. The alarm mechanism 280 includes a switch 283 that switches ON and OFF due to the air flow in the flow path forming member 281 connected to the pressure regulating valve 270, as well as a light-emitting lamp that becomes illuminated when the switch 283 is closed. The switch 283 is a valve comprising a moving body 285 that moves due to the occurrence of air flow in the flow path 282 upon the activation of the pressure regulating valve 270, and traveling contacts 286a, 286b are respectively mounted to the surfaces of movable bodies 285b, 285c disposed at opposite ends of a linking rod 285a disposed at one end of the moving body 285, as in the eighth embodiment. Fixed contact elements 287a, 287b are disposed on a circuit substrate 289 through which the moving body 285 passes. When either of the pressure regulating valves opens, the moving body 285 of the alarm mechanism 280 moves, selectively causing one of the traveling contacts 286a, 286b to come into contact with one of the fixed contact elements 287a, 287b, thereby causing the switching circuit to drive the illumination of the light-emitting lamp.

### J. Tenth Embodiment

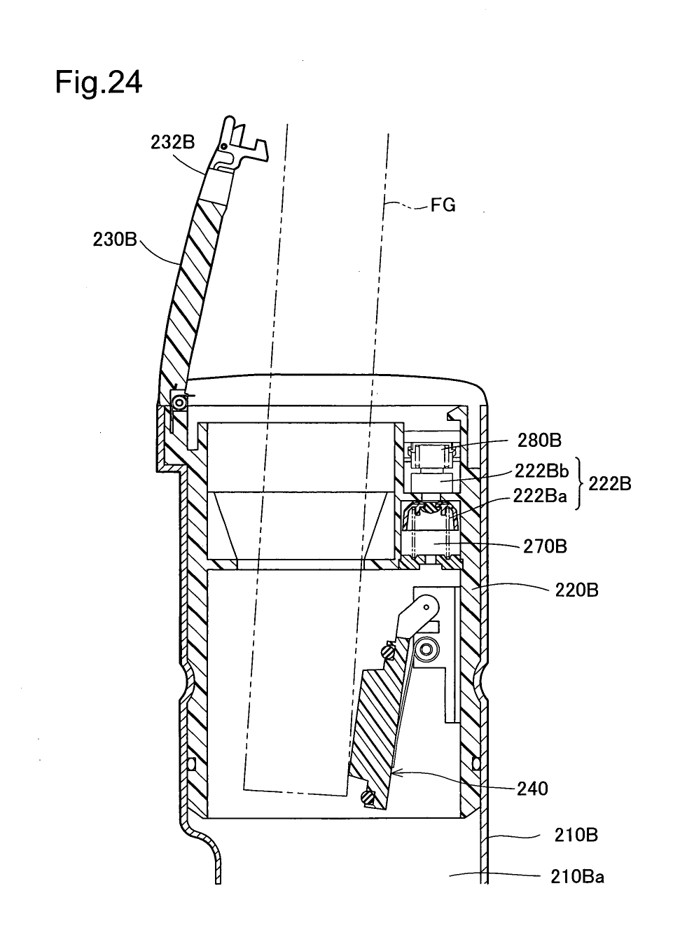

FIG. 24 is a cross-sectional view of a fueling apparatus for a fuel tank equipped with the alarm mechanism pertaining to a tenth embodiment. The embodiment is a variation of the ninth embodiment, and differs therefrom in regard to the placement of the alarm mechanism that provides a warning regarding an abnormality in the pressure regulating valve. A housing chamber 222B is formed in the path forming body 220B of an inlet pipe 210B of the fueling apparatus. The housing chamber 222B includes a lower chamber 222Ba and an upper chamber 222Bb, a pressure regulating valve 270B that serves as a negative pressure valve is disposed in the lower chamber 222Ba, and an alarm mechanism 280B having essentially the same construction as the alarm mechanism shown in FIG. 11 is disposed in the upper chamber 222Bb. Through the construction, negative pressure in the fuel path 210Ba downstream from the second shut-off mechanism 240B can be regulated, the alarm mechanism 280B can provide warning of the activation of the pressure regulating valve 270B, and the existence of such warning can be observed from the display window 232B of the first shut-off mechanism 230B. In addition, the pressure regulating valve and alarm mechanism may be appropriately selected from the embodiments described above.

The foregoing detailed description of the invention has been provided for the purpose of explaining the principles of the invention and its practical application, thereby enabling others skilled in the art to understand the invention for various embodiments and with various modifications as are suited to the particular use contemplated. The foregoing detailed description is not intended to be exhaustive or to limit the invention to the precise embodiments disclosed. Modifications and equivalents will be apparent to practitioners skilled in this art and are encompassed within the spirit and scope of the appended claims.

What is claimed is:

1. A shut-off device that includes a pressure regulating valve that regulates an inner pressure of a fuel tank, the shut-off device comprising:
an alarm mechanism that indicates that the pressure regulating valve is activated due to an air flow resulting from an opening action of the pressure regulating valve.

2. The shut-off device according to claim 1, wherein the pressure regulating valve includes at least one of a negative pressure valve that opens when the inner pressure of the fuel tank exceeds atmospheric pressure by a predetermined negative lever and a positive pressure valve that opens when the inner pressure of the fuel tank exceeds atmospheric pressure by a predetermined positive level.

3. The shut-off device according to claim 2, wherein the alarm mechanism is a whistle mechanism through which sound is emitted via the air flow resulting from the opening action of the pressure regulating valve.

4. The shut-off device according to claim 3, wherein the alarm mechanism includes a flow path forming member that leads outside air from the whistle mechanism to the pressure regulating valve.

5. The shut-off device according to claim 4, wherein the whistle mechanism includes a reed that vibrates due to the air flow resulting from the opening action of the pressure regulating valve.

6. The shut-off device according to claim 2, wherein the alarm mechanism includes a flow path forming member that leads outside air to the pressure regulating valve and a moving body that is disposed inside the flow path forming member and movable from a standby position to an alarm position, and
the alarm mechanism is configured such that the moving body is visibly observable from outside at the alarm position when the moving body moves from the standby position to the alarm position due to the air flow resulting from the opening action of the pressure regulating valve.

7. The shut-off device according to claim 6, wherein the alarm mechanism includes a display window that enables the moving body to be visibly observable at the alarm position.

8. The shut-off device according to claim 7, wherein the alarm mechanism includes a positioning mean that positions and fixes the moving body at the alarm position when the moving body moves to the alarm position.

9. The shut-off device according to claim 7, wherein the alarm mechanism includes a spring that applies a spring force to the moving body toward the standby position and a positioning mean that positions and fixes the moving body at the alarm position when the moving body moves to the alarm position.

10. The shut-off device according to claim 7, wherein the alarm mechanism has a fluid chamber that houses a display fluid, and the moving body includes a valve element that shut flowing out of the display fluid from the fluid chamber and causes the display fluid to flow out from the fluid chamber when the moving body moves from the standby position to the alarm position.

11. The shut-off device according to claim 7, wherein the alarm mechanism has a fluid chamber that houses a display fluid, and the moving body includes a valve element that shut flowing out of the display fluid from the fluid chamber and causes the display fluid to flow out from the fluid chamber when the moving body moves from the standby position to the alarm position, and a pressure receiving element that forms integrally with the valve element and receives a differential pressure resulting from the air flow due to the opening of the pressure regulating valve.

12. The shut-off device according to claim 7, wherein the alarm mechanism includes a moving body that selectively moves in different directions due to the air flow resulting from the opening action of the negative pressure valve and the air flow resulting from the opening action of the positive pressure valve, and a first alarm surface, a second alarm surface and a third alarm surface that indicate a position of the moving body,
the first alarm surface indicating the standby position of the moving body, the second alarm surface indicating the alarm position at which the negative pressure valve is activated, and the third alarm surface indicating the alarm position at which the positive pressure valve is activated.

13. The shut-off device according to claim 12, wherein the alarm mechanism is configured such that the first through third alarm surfaces selectively faces the display window by the movement of the moving body.

14. The shut-off device according to claim 2, wherein the alarm mechanism includes a moving body that moves due to the air flow from the pressure regulating valve, a switch that turns ON and OFF based on the movement of the moving body, and a lamp that becomes illuminated when the switch is ON.

15. A fueling apparatus for a fuel tank that includes an inlet pipe having a fuel path that supplies fuel to the fuel tank, the apparatus comprising:
a pressure regulating valve that regulates an inner pressure of the fuel tank and is disposed in the inlet pipe; and
an alarm mechanism that indicates that the pressure regulating valve is activated due to an air flow resulting from an opening action of the pressure regulating valve.

16. The fueling apparatus according to claim 15, further including a shut-off mechanism that is disposed at an opening of the inlet pipe and closes the fuel path,
wherein the pressure regulating valve is disposed to regulate an pressure of the fuel path on the side of the fuel tank that is tightly closed by the shut-off mechanism.
